(19) United States
(12) Patent Application Publication
(10) Pub. No.: US 2021/0404544 A1
(43) Pub. Date: Dec. 30, 2021

(54) STRAIN WAVE GEARING UNIT

(71) Applicant: HARMONIC DRIVE SYSTEMS INC., Tokyo (JP)

(72) Inventors: Hiroaki KIMURA, Azumino-shi (JP); Yoshihide KIYOSAWA, Azumino-shi (JP); Jun HANDA, Azumino-shi (JP)

(73) Assignee: HARMONIC DRIVE SYSTEMS INC., Tokyo (JP)

(21) Appl. No.: 17/191,775

(22) Filed: Mar. 4, 2021

(30) Foreign Application Priority Data
Jun. 29, 2020 (JP) 2020-111254

(51) Int. Cl. F16H 49/00; F16H 57/021

(52) U.S. Cl. CPC F16H 49/001; F16H 2049/003; F16H 57/021

(57) ABSTRACT

A strain wave gearing unit has a unit housing, a strain wave gearing, and a bearing device. Balls of a bearing part of the bearing device are positioned on the diametrically outer side with respect to a cylindrical barrel part of an externally toothed gear. The diameter S of the balls is 0.05 to 0.15 times the pitch diameter D of the externally toothed gear. The centers of the balls are positioned between a point at a distance of 1.2 times the diameter S toward the cylindrical-barrel-part side from an inner-side end surface of a diaphragm along a center axis and a point at a distance of 1 times the diameter S toward a side opposite the cylindrical barrel part from the inner-side end surface. The bearing device can be configured to be used in common for strain wave gearing units having different axial lengths.

### TECHNICAL FIELD

The present invention relates to a strain wave gearing unit provided with a unit housing, a cup-type strain wave gearing incorporated inside the unit housing, and a bearing device by which an externally toothed gear of the strain wave gearing is supported in such a state as to be capable of rotating relative to the unit housing.

### BACKGROUND ART

A strain wave gearing unit is disclosed in Patent document 1 (JPU 3219909 B), for example. In a reducer disclosed in this document, a rigid internally toothed gear, a cup-shaped flexible externally toothed gear, and a wave generator are accommodated in a cylindrical housing. A boss portion of the externally toothed gear is supported in a rotatable state by the housing via a cross roller bearing.

In order to reduce the axial length of a strain wave gearing unit, a configuration is employed in which a bearing, which is generally aligned coaxially with a cup-shaped externally toothed gear in the axial direction, is disposed on the outer-peripheral side of the externally toothed gear. For example, as disclosed in Patent document 2(JP 2020-509311 A), a cross roller bearing is disposed in such a state as to surround a cylindrical barrel part of the cup-shaped externally toothed gear. This makes it possible to flatten the strain wave gearing unit.
Patent Document 1: JPU 3219909 B
Patent Document 2: JP 2020-509311 A

### SUMMARY OF THE INVENTION

### Problems to be Solved by the Invention

In strain wave gearing units, at times it is necessary for elements to have the same outside-diameter dimensions but different axial lengths, in accordance with the assembly location, application, etc., of the strain wave gearing unit. Therefore, a plurality of strain wave gearing units having different axial lengths are prepared in advance, and a strain wave gearing unit having an axial length that is suited for requested specifications is provided. It may also be necessary to prepare numerous constituent components that constitute the strain wave gearing units having different axial lengths, in accordance with the axial length.

In view of the foregoing, it is an object of the present invention to make it possible to inexpensively manufacture strain wave gearing units having different axial lengths by using components in common.

### Means of Solving the Problems

The strain wave gearing unit of the present invention has a tubular unit housing, a strain wave gearing incorporated inside the unit housing, and a bearing device by which a rotation-outputting member of the strain wave gearing is supported in such a state as to be capable of rotating relative to the unit housing. The strain wave gearing is provided with a rigid internally toothed gear disposed inside the unit housing, a cup-shaped flexible externally toothed gear disposed coaxially inside the internally toothed gear, and a wave generator fitted coaxially inside the externally toothed gear. The internally toothed gear is secured to, or formed integrally with, an inner-peripheral-surface portion on a side of a first end part of the unit housing. The externally toothed gear serves as the rotation-outputting member, and is provided with a cylindrical barrel part in which a front end on the side of the first end part is formed as a front-end opening, a diaphragm extending radially inward from a rear end of the cylindrical barrel part, an annular rigid boss formed integrally with the inner-peripheral edge of the diaphragm, and external teeth formed on an outer-peripheral-surface portion on a side of the rear end of the cylindrical barrel part, the external teeth facing internal teeth of the internally toothed gear. The wave generator is fitted inside the portion of the cylindrical barrel part in which the external teeth are formed. The bearing device is provided with a bearing part and an output shaft part. The bearing part is provided with an outer race secured to an inner-peripheral-surface portion on a side of a second end part of the unit housing, an inner race disposed in such a state as to surround a portion on the side of the rear end of the cylindrical barrel part of the externally toothed gear, and a plurality of rolling elements inserted in an annular raceway formed between the outer race and the inner race. The output shaft part is a ring-shaped member, which is provided with an outer-peripheral-side portion linked to the inner race, and an inner-peripheral-side portion secured to the boss.

In the strain wave gearing unit having this configuration, the rolling elements are positioned on the diametrically outer side with respect to the cylindrical barrel part of the externally toothed gear. In addition, the diameter S of the rolling elements is 0.05 to 0.15 times the inside diameter D of the cylindrical barrel part of the externally toothed gear. Furthermore, the centers of the rolling elements are positioned between a point at a distance of 1.2 times the diameter S of the rolling elements toward the cylindrical-barrel-part side from an inner-side end surface of the diaphragm along a center axis, the inner-side end surface being linked to the inner-peripheral surface of the cylindrical barrel part, and a point at a distance of 1 times the diameter S toward a side opposite the cylindrical barrel part from the inner-side end surface along the center axis.

Defining the position and diameter of the rolling elements of the bearing device in the manner described above makes it possible to ensure the bearing rigidity necessary for the strain wave gearing unit, and configure the bearing device provided with the bearing part and the output shaft part to be used in common for strain wave gearing units in which there are incorporated cup-shaped externally toothed gears that have the same diameter but different barrel-part lengths.

For example, in cases where a series of strain wave gearing units including at least first and second strain wave gearings that have the same outside diameter but different axial lengths are provided, the strain wave gearing units being formed as the strain wave gearing units having the configuration described above, the first strain wave gearing unit is provided with a first externally toothed gear as the externally toothed gear, and the second strain wave gearing unit is provided with a second externally toothed gear as the externally toothed gear, the second externally toothed gear having the same pitch diameter as the first externally toothed gear but being lower in axial length than the first externally toothed gear. In this case, the bearing device can be used in common for both of the first and second strain wave gearing units.

### BRIEF DESCRIPTION OF THE DRAWINGS

FIG. 1A is a vertical cross-sectional view of the strain wave gearing unit having the greatest axial length in a series of strain wave gearing units to which the present invention is applied;

FIG. 1B is a vertical cross-sectional view of a bearing device in the strain wave gearing unit shown in FIG. 1A;

FIG. 1C is a vertical cross-sectional view of the strain wave gearing unit having the lowest axial length in the series of strain wave gearing units;

FIG. 2A is a vertical cross-sectional view of another example of the bearing device; and

FIG. 2B is a vertical cross-sectional view of yet another example of the bearing device.

### MODE FOR CARRYING OUT THE INVENTION

Embodiments of the strain wave gearing unit to which the present invention is applied are described below with reference to the accompanying drawings. The embodiments described below indicate examples of the present invention, but the present invention is not limited to these embodiments.

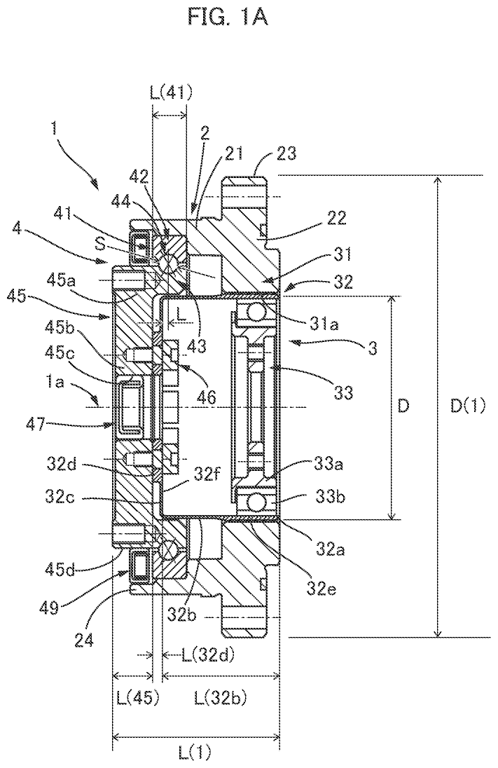

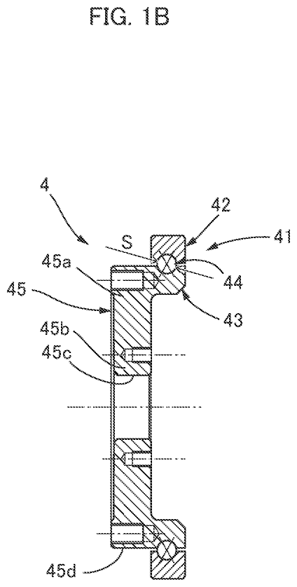

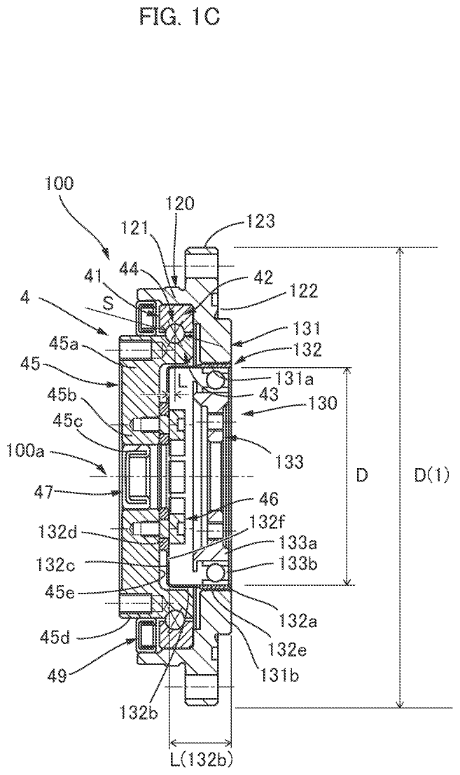

FIG. 1A is a vertical cross-sectional view of the strain wave gearing unit having the greatest axial length among a plurality of strain wave gearing units having different axial lengths, these strain wave gearing units being included in a series of strain wave gearing units pertaining to an embodiment. FIG. 1B is a vertical cross-sectional view of a bearing device. FIG. 1C is a vertical cross-sectional view of the strain wave gearing unit having the lowest axial length, this strain wave gearing unit being included in the aforementioned series.

First, the greatest-axial-length strain wave gearing unit included in the series of strain wave gearing units is described with reference to FIGS. 1A and 1B. The strain wave gearing unit 1 has a tubular unit housing which is a cylindrical unit housing 2 in this example, a cup-type strain wave gearing 3 incorporated inside the unit housing 2, and a bearing device 4 by which a rotation-outputting member (externally toothed gear) of the strain wave gearing 3 is supported so as to be capable of rotating relative to the unit housing 2.

The unit housing 2 is provided with a cylinder part 21, and a large-diameter attachment flange 23 that is formed on an outer-peripheral-surface portion of the cylinder part 21 on the side of a first end part 22 in the direction of a center axis 1a. The outside-diameter dimension of the strain wave gearing unit 1 is defined by the outside-diameter dimension D(1) of the attachment flange 23.

The strain wave gearing 3 is provided with a rigid internally toothed gear 31 that is formed in an annular shape and disposed coaxially inside the unit housing 2, a cup-shaped flexible externally toothed gear 32 disposed coaxially inside the internally toothed gear 31, and a wave generator 33 fitted coaxially inside the externally toothed gear 32. The internally toothed gear 31 is secured to, or formed integrally with, an inner-peripheral-surface portion on the first-end-part 22 side of the unit housing 2. In the present example, the unit housing 2 and the internally toothed gear 31 are manufactured as a single component. The internally toothed gear 31 can also be integrated with the inner-peripheral-surface portion of the unit housing 2 by cast molding.

The externally toothed gear 32 is a rotation-outputting member of the strain wave gearing 3. The externally toothed gear 32 is formed in a cup shape overall, and is provided with a cylindrical barrel part 32b that has a front-end opening 32a on the side of the first end part 22, a discoid diaphragm 32c extending radially inward from a rear end of the cylindrical barrel part 32b, an annular rigid boss 32d formed integrally with the inner-peripheral edge of the diaphragm 32c, and external teeth 32e formed on an outer-peripheral-surface portion of the cylindrical barrel part 32b. The external teeth 32e are formed at positions facing internal teeth 31a of the internally toothed gear 31 and are capable of meshing with the internal teeth 31a.

The wave generator 33 is fitted coaxially inside the portion of the cylindrical barrel part 32b in which the external teeth 32e are formed. The wave generator 33 is provided with an annular rigid plug 33a, and a wave bearing 33b mounted on an ellipsoidal outer-peripheral surface of the rigid plug 33a. Due to the wave generator 33, the portion of the externally toothed gear 32 in which the external teeth 32e are formed is flexed in an ellipsoidal shape, and the external teeth 32e mesh with the internal teeth 31a at positions at both long-axis ends of the ellipsoidal shape.

The bearing device 4 is provided with a bearing part 41 formed from a four-point contact ball bearing, and an output shaft part 45. The bearing part 41 is provided with an outer race 42 coaxially secured to an inner-peripheral-surface portion on a side of a second-end-part 24 of the unit housing 2, an inner race 43 disposed to coaxially surround a portion on the rear-end side of the cylindrical barrel part 32b of the externally toothed gear 32, and a plurality of balls 44 (rolling elements) inserted in an annular raceway formed between the outer race 42 and the inner race 43.

The output shaft part 45 is a ring-shaped plate of uniform thickness, and is formed integrally with the inner race 43 in the present example. An outer-peripheral-side portion 45a of the output shaft part 45 is linked to the inner race 43, and an inner-peripheral-side portion 45b of the output shaft part 45 is in contact with the boss 32d in the direction of the center axis 1a. In the present example, the inner-peripheral-side portion 45b is securely fastened in a coaxial manner to the boss 32d by a plurality of fastening bolts 46 disposed at equiangular intervals in the circumferential direction.

A center opening 45c is formed in the output shaft part 45, the center opening 45c being sealed by a discoid seal cap 47 or a plate-form cover having a prescribed thickness. In addition, a space between a circular outer-peripheral surface 45d on the outer-peripheral-side portion 45a of the output shaft part 45 and a circular inner-peripheral surface on the second end part 24 of the unit housing 2 is sealed by an annular oil seal 49 disposed adjacent to the outer race 42.

A ball bearing, in which the diameter S of balls 44 thereof is 0.05 to 0.15 times the inside diameter D of the cylindrical barrel part 32b of the externally toothed gear 32, is used as the bearing part 41 of the bearing device 4.

0.05≤S≤0.15D

As the diameter S of the balls 44 decreases, the dynamic load rating of the bearing part 41 also decreases. Conversely, when the diameter S increases, the volume occupied by the bearing part 41 increases, presenting a disadvantage for flattening and reducing the weight of the strain wave gearing unit 1. By setting the lower-limit value of the diameter S of the balls 44 to 0.05 D and setting the upper-limit value of the diameter S to 0.15 D, flattening and a reduction in weight are achieved while ensuring the necessary dynamic load rating.

The depth dimension of the cylindrical barrel part 32b of the externally toothed gear 32 (axial-direction length dimension from an open end to the diaphragm) is designated as L(32b), the axial-direction thickness dimension of the boss 32d of the externally toothed gear 32 is designated as L(32d), the axial-direction thickness dimension of the output shaft part 45 of the bearing device 4 is designated as L(45), and the axial-direction thickness dimension of the inner and outer races of the bearing part 41 is designated as L(41).

The thickness dimension L(45) of the output shaft part 45 and the thickness dimension L(32d) of the boss 32d are set to thickness dimensions necessary for these two elements to be fastened. Because the output shaft part 45 is securely fastened to the externally toothed gear 32 in the axial direction, the total length L(1) of the strain wave gearing unit 1 is calculated according to the following equation, even for the lowest total length L(1).

L(1)=L(32b)+L(32d)+L(45)

In the bearing device 4 in the present example, in order to flatten the strain wave gearing unit 1, the bearing part 41 having the necessary thickness dimension L(41) is disposed so that, to the extent possible, the total length of the strain wave gearing unit 1 does not increase from the lowest value.

More specifically, in the bearing part 41 of the bearing device 4, the balls 44 are positioned on the diametrically outer side with respect to the cylindrical barrel part 32b of the externally toothed gear 32. In addition, the bearing part 41 is disposed so that the centers of the balls 44 are positioned between a point at a distance of 1.2 times the diameter S of the balls 44 toward the cylindrical-barrel-part 32b side from an inner-side end surface 32f of the diaphragm 32c along the center axis 1a and a point at a distance of 1 times the diameter S toward a side opposite the cylindrical barrel part 32b from the inner-side end surface 32f along the center axis 1a.

Specifically, a distance L is set to a value that satisfies the following relationship, where L is the distance from the centers of the balls 44 along the center axis 1a to the inner-side end surface 32f of the diaphragm 32c, the inner-side end surface 32f being linked to the inner-peripheral surface of the cylindrical barrel part 32b, and the direction from the inner-side end surface 32f toward the cylindrical-barrel-part 32b side is designated as a positive direction.

−S≤L≤1.2S

When the axial-direction position of the bearing part 41 relative to the output shaft part 45 moves by a large amount toward the output-shaft-part 45 side (when the center position of the balls 44 moves by a large amount toward the output-shaft-part 45 side), the total length L(1) of the strain wave gearing unit 1 is determined by the dimension obtained by adding the distance L, the axial-direction thickness dimension of the oil seal 49, and the length dimension of a spigot portion to the depth dimension L(32b) of the externally toothed gear 32, making it impossible to realize a flattened structure. Conversely, when the position of the bearing part 41 moves by a large amount in the direction of the internally toothed gear 31 (when the center position of the balls 44 moves by a large amount in the direction of the internally toothed gear 31), there is a concern that the bearing part 41 will interfere with the teeth of the externally toothed gear in the axial direction in cases involving a strain wave gearing unit having a low axial length. As a result, the bearing device 4 would not be able to be used in common for externally toothed gears having different axial lengths. From such standpoints, the lower-limit value of the distance L in the present example is set to −S, and the upper-limit value thereof is set to 1.2 S.

The bearing device 4 in the present example, configured in this manner, is used without modification as a bearing device in the strain wave gearing unit 100 having the lowest axial length shown in FIG. 1C.

The flat strain wave gearing unit 100 shown in FIG. 1C has the same structure as the strain wave gearing unit 1 described above. The strain wave gearing unit 100 has a cylindrical unit housing 120, a cup-type strain wave gearing 130 incorporated inside the unit housing 120, and a bearing device 4 by which a rotation-outputting member (externally toothed gear) of the strain wave gearing 130 is supported so as to be capable of rotating relative to the unit housing 120.

The unit housing 120 is provided with a cylinder part 121, and a large-diameter attachment flange 123 that is formed on an outer-peripheral-surface portion of the cylinder part 121 on a side of a first end part 122 in the direction of a center axis 100a. The outside-diameter dimension of the unit housing 120 is the same as that of the unit housing 2 described above, but the axial length of the unit housing 120 is less than that of the unit housing 2. The axial length of the unit housing 120 is set in accordance with the axial length of the mounted strain wave gearing 130, specifically the axial length of an externally toothed gear 132.

The strain wave gearing 130 is provided with a rigid internally toothed gear 131 that is formed in an annular shape and disposed coaxially inside the unit housing 120, a cup-shaped flexible externally toothed gear 132 disposed coaxially inside the internally toothed gear 131, and a wave generator 133 fitted coaxially inside the externally toothed gear 132. The internally toothed gear 131 is secured to, or formed integrally with, an inner-peripheral-surface portion on the side of the first end part 122 of the unit housing 120. In the present example, the unit housing 120 and the internally toothed gear 131 are manufactured as a single component. The internally toothed gear 131 can also be integrated with the inner-peripheral-surface portion of the unit housing 120 by cast molding.

The externally toothed gear 132 is a rotation-outputting member of the strain wave gearing 130. The externally toothed gear 132 is formed in a cup shape overall, and is provided with a cylindrical barrel part 132b having a front-end opening 132a on the side of the first end part 122, a discoid diaphragm 132c extending radially inward from a rear end of the cylindrical barrel part 132b, an annular rigid boss 132d formed integrally with the inner-peripheral edge of the diaphragm 132c, and external teeth 132e formed on an outer-peripheral-surface portion of the cylindrical barrel part 132b, the external teeth 132e facing internal teeth 131a of the internally toothed gear 131. The outside-diameter dimension (pitch diameter) of the externally toothed gear 132 is the same as that of the externally toothed gear 32 described above, but the axial length of the cylindrical barrel part 132b is less than that of the cylindrical barrel part 32b of the externally toothed gear 32. In association with this difference, the tooth width of the external teeth 132e is also less than that of the external teeth 32e described above.

The wave generator 133 is fitted coaxially inside the portion of the cylindrical barrel part 132b in which the external teeth 132e are formed. The wave generator 133 is provided with an annular rigid plug 133a, and a wave bearing 133b mounted on an ellipsoidal outer-peripheral surface of the rigid plug 133a. Due to the wave generator 133, the portion of the externally toothed gear 132 in which the external teeth 132e are formed is flexed in an ellipsoidal shape, and the externally toothed gear 132 meshes with the internally toothed gear 131 at positions at both long-axis ends of the ellipsoidal shape. The outside-diameter dimension of the wave generator 133 is the same as that of the wave generator 33 described above, but the wave generator 133 is formed to a thickness dimension that corresponds to the tooth width of the external teeth 132e, and is thinner than the wave generator 33 described above.

In a state where the bearing device 4 additionally used in the flat strain wave gearing unit 100 is mounted in the unit housing 120, the inner race 43 of the bearing device 4 faces the end surface of the internally toothed gear 131 with a nominal gap therebetween. In this state, the distance L1 from an outer-side end surface 131b of the internally toothed gear 131 to an inner-side end surface 45e of the output shaft part 45 is set so as to be the same as the axial length of the flat externally toothed gear 132. Specifically, the amount by which the inner race 43 formed integrally with the output shaft part 45 protrudes toward the internally toothed gear 131 (width dimension of the inner-peripheral surface of the inner race) is set in accordance with the axial length of the lowest-axial-length externally toothed gear 132 included in the series. This makes it possible for even the lowest-axial-length externally toothed gear 132 to be mounted inside the internally toothed gear 131 and the inner race 43.

The bearing part 41 is disposed so that the centers of the balls 44 are positioned between a point at a distance of 1.2 times the diameter S of the balls 44 toward the cylindrical-barrel-part 132b side from an inner-side end surface 132f of the diaphragm 132c along the center axis 100a and a point at a distance of 1 times the diameter S of the balls 44 toward a side opposite the cylindrical barrel part 132b from the inner-side end surface 132f along the center axis 100a. Specifically, a distance L is set to a value that satisfies the following relationship, where L is the distance from the centers of the balls 44 along the center axis 100a to the inner-side end surface 132f of the diaphragm 132c, the inner-side end surface 132f being linked to the inner-peripheral surface of the cylindrical barrel part 132b, and the direction from the inner-side end surface 132f toward the cylindrical-barrel-part 132b side is designated as a positive direction.

−S≤L≤1.2S

As described above, the bearing device 4 for use in common is used for the strain wave gearing units 1, 100 having different axial lengths. The bearing part 41 of the bearing device 4 is provided with necessary characteristics, such as bearing rigidity. Thus, in the series of strain wave gearing units having different axial lengths, it is possible to inexpensively construct strain wave gearing units having different axial lengths using a bearing device 4 for use in common.

(Other Examples of Bearing Device)

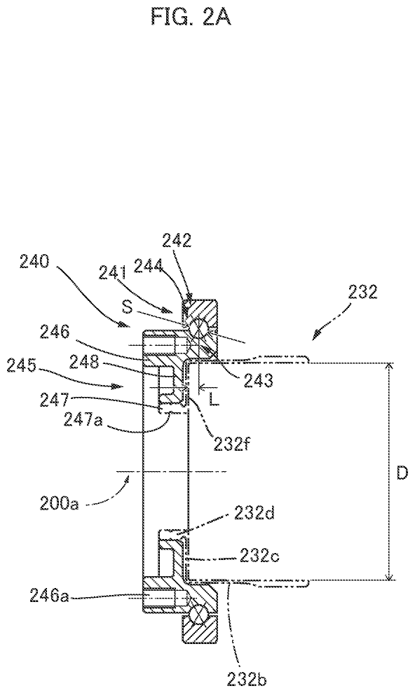

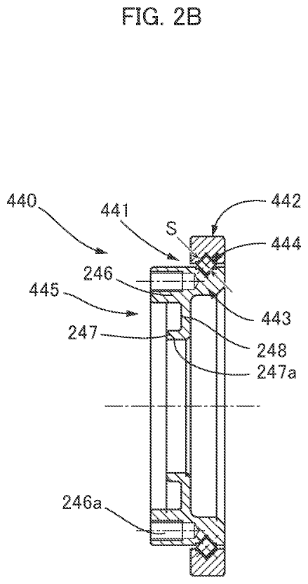

FIG. 2A is a schematic cross-sectional view of another example of the bearing device that can be used in common for strain wave gearing units having different axial lengths. The basic configuration of the bearing device 240 shown in FIG. 2A is the same as that of the bearing device 4. The bearing device 240 is provided with a bearing part 241 formed from a four-point contact ball bearing, and an output shaft part 245. The bearing part 241 is provided with an outer race 242, an inner race 243, and a plurality of balls 244 (rolling elements) inserted in an annular raceway formed between the outer race 242 and the inner race 243.

The output shaft part 245 is a ring-shaped body, and is formed integrally with the inner race 243 in the present example. The output shaft part 245 is provided with an outer-peripheral-side annular part 246 that has a rectangular cross-section and is linked to the inner race 243, an inner-peripheral-side annular part 247 that has a rectangular cross-section and is provided with a center opening 247a, and a ring-shaped plate portion 248 extending radially inward from the circular inner-peripheral surface of the outer-peripheral-side annular part 246. The inner-peripheral edge part of the ring-shaped plate portion 248 is bent outward at a right angle, thereby forming the inner-peripheral-side annular part 247. The thickness of the ring-shaped plate portion 248 of the output shaft part 245 is less than that of the outer-peripheral-side annular part 246, and the output shaft part 245 is formed so as to be lightweight. Bolt holes 246a for fastening a load-side member (not shown) are formed in the outer-peripheral-side annular part 246 at equiangular intervals in the circumferential direction.

When the bearing device 240 having this configuration is used, the boss of the externally toothed gear can be joined by welding to the output shaft part 245 with which the inner race 243 is integrally formed. For example, as indicated by virtual lines in FIG. 2A, an externally toothed gear 232 provided with a discoid boss 232d is used, the boss 232d being able to be fitted into the center opening 247a in the output shaft part 245. In a state where the boss 232d is coaxially fitted into the center opening 247a, the inner-peripheral edge part of the inner-peripheral-side annular part 247 of the output shaft part 245 and the outer-peripheral edge part of the boss 232d are joined by welding across the entire circumference. In this case, the need for components such as fastening bolts is obviated. In addition, both the inner-peripheral-side annular part 247 of the output shaft part 245 and the boss 232d of the externally toothed gear 232 can be formed as low-plate-thickness portions. This is beneficial for flattening and reducing the weight of the strain wave gearing units.

In the bearing part 241 of the bearing device 240 in the present example as well, the balls 244 are positioned on the diametrically outer side with respect to the cylindrical barrel part 232b of the externally toothed gear 232. A bearing in which the diameter S of the balls 244 thereof is 0.05 to 0.15 times the inside diameter D of the cylindrical barrel part 232b of the externally toothed gear 232 is used as the bearing part 241.

0.05D≤S≤0.15D

In addition, the bearing part 241 is disposed so that the centers of the balls 244 are positioned between a point at a distance of 1.2 times the diameter S of the balls 244 toward the cylindrical-barrel-part 232b side from an inner-side end surface 232f of a diaphragm 232c along a center axis 200a and a point at a distance of 1 times the diameter S toward a side opposite the cylindrical barrel part 232b from the inner-side end surface 232f along the center axis 200a. Specifically, a distance L is set to a value that satisfies the following relationship, where L is the distance from the centers of the balls 244 along the center axis 200a to the inner-side end surface 232f of the diaphragm 232c, the inner-side end surface 232f being linked to the inner-peripheral surface of the cylindrical barrel part 232b, and the direction from the inner-side end surface 232f toward the cylindrical-barrel-part 232b side is designated as a positive direction.

−S≤L≤1.2S

FIG. 2B is a schematic cross-sectional view of an example of a bearing device that can be used in lieu of the bearing device 240. A cross roller bearing is used as a bearing part 441 in the bearing device 440 shown in FIG. 2B. The cross roller bearing is provided with an outer race 442, an inner race 443, and a plurality of cylindrical rollers 444 inserted in an annular raceway that is formed between the outer race 442 and the inner race 443 and has a rectangular cross-section. The cylindrical rollers 444 are inserted into the raceway so that the center axes thereof are perpendicular to each other. An output shaft part 445 of the bearing device 440 has the same configuration as the output shaft part 245 of the bearing device 240 described above; therefore, the same reference symbols are associated with corresponding sites, and description of these sites is omitted.

1. A strain wave gearing unit comprising:
a unit housing having a tubular shape;
a strain wave gearing incorporated inside the unit housing; and
a bearing device for rotatably supporting a rotation-outputting member of the strain wave gearing relative to the unit housing,
wherein
the strain wave gearing is provided with:
a rigid internally toothed gear disposed inside the unit housing;
a cup-shaped flexible externally toothed gear disposed coaxially inside the internally toothed gear; and
a wave generator fitted coaxially inside the externally toothed gear;
wherein
the internally toothed gear is secured to, or formed integrally with, an inner-peripheral-surface portion on a side of a first end part of the unit housing;
the externally toothed gear serves as the rotation-outputting member, and is provided with: a cylindrical barrel part having a front end on the side of the first end part; a diaphragm extending radially inward from a rear end of the cylindrical barrel part; an annular rigid boss formed integrally with an inner-peripheral edge of the diaphragm; and external teeth formed on an outer-peripheral-surface portion of the cylindrical barrel part facing internal teeth of the internally toothed gear, the front end of the cylindrical barrel part being an opening end; and
the wave generator is fitted inside the cylindrical barrel part where the external teeth are formed,
wherein
the bearing device is provided with a bearing part and an output shaft part;
the bearing part is provided with:
an outer race secured to an inner-peripheral-surface portion on a side of a second end part of the unit housing;
an inner race disposed to surround a portion of the cylindrical barrel part of the externally toothed gear, the portion being on the side of the rear end part; and
a plurality of rolling elements inserted in an annular raceway formed between the outer race and the inner race; and
the output shaft part has an outer-peripheral-side portion linked to the inner race, and an inner-peripheral-side portion secured to the boss, and
wherein
the rolling elements are positioned on a diametrically outer side with respect to the cylindrical barrel part of the externally toothed gear;
a diameter of the rolling elements is 0.05 to 0.15 times an inside diameter D of the cylindrical barrel part of the externally toothed gear; and
centers of the rolling elements are positioned between a point at a distance of 1.2 times the diameter of the rolling elements toward a side of the cylindrical barrel part from an inner-side end surface of the diaphragm along a center axis, the inner-side end surface being linked to an inner-peripheral surface of the cylindrical barrel part, and a point at a distance of 1 times the diameter toward a side opposite the cylindrical barrel part from the inner-side end surface along the center axis.

2. The strain wave gearing unit according to claim 1,
wherein
the output shaft part has an inner-peripheral edge part, and the boss has an outer-peripheral edge part, and
the inner-peripheral edge part and the outer-peripheral edge part are joined by welding across entire circumferences thereof.

3. The strain wave gearing unit according to claim 1,
wherein
the output shaft part is provided with:
an outer-peripheral-side annular part that has a rectangular cross-section and is linked to the inner race;
a ring-shaped plate portion extending radially inward from an inner-peripheral surface of the outer-peripheral-side annular part; and
an inner-peripheral-side annular part formed on the inner-peripheral edge part of the ring-shaped plate portion, the inner-peripheral-side portion having a rectangular cross-section and being provided with a center opening into which the boss of the externally toothed gear is inserted; and
wherein
a thickness of the ring-shaped plate portion is less than that of the outer-peripheral-side annular part; and
the inner-peripheral edge part of the inner-peripheral-side annular part and the outer-peripheral edge part of the boss are joined by welding across entire circumferences thereof.

4. The strain wave gearing unit according to claim 3,
wherein
the boss is provided with a center opening, and
the center opening of the boss is sealed by a plate-form cover.

5. The strain wave gearing unit according to claim 1,
wherein
the internally toothed gear is integrated with the inner-peripheral-surface portion on the side of the first end part of the unit housing by cast molding.

6. The strain wave gearing unit according to claim 1,
wherein
the bearing part of the bearing device is a cross roller bearing or a four-point contact ball bearing.

7. A series of strain wave gearing units that includes at least first and second strain wave gearing units having the same outside diameter but different axial lengths, the strain wave gearing units being formed as strain wave gearing units according to claim 1, wherein:
the first strain wave gearing unit is provided with a first externally toothed gear as the externally toothed gear;
the second strain wave gearing unit is provided with a second externally toothed gear as the externally toothed gear, the second externally toothed gear having the same pitch diameter as the first externally toothed gear but being lower in axial length than the first externally toothed gear; and
the bearing device is used in common for the first and second strain wave gearing units.
